(19) United States
(12) Patent Application Publication
(10) Pub. No.: US 2015/0286815 A1
(43) Pub. Date: Oct. 8, 2015

(54) ACCESS CONTROL MANAGEMENT APPARATUS AND METHOD FOR OPEN SERVICE COMPONENTS

(71) Applicant: Electronics and Telecommunications Research Institute, Daejeon (KR)

(72) Inventors: Ki Sook CHUNG, Daejeon (KR); Hyun Joo BAE, Daejeon (KR)

(21) Appl. No.: 14/620,870

(22) Filed: Feb. 12, 2015

(30) Foreign Application Priority Data
Apr. 3, 2014 (KR) 10-2014-0040173

(51) Int. Cl. G06F 21/44; H04L 29/06; G06F 21/45

(52) U.S. Cl. CPC G06F 21/44; G06F 21/45; H04L 63/08

(57) ABSTRACT

An access control management apparatus and method for open service components are provided. The access control management apparatus may include a header extractor configured to extract a header from a request message for a service component which is received from an application, an authentication manager configured to authenticate a permission of the application for the service component using an application ID, a service key for the service component and an authorization code which are included in the header, and a history manager configured to store an execution result of the service component if the permission is authenticated.

Priority to Korean patent application number 1 0-201 4-00401 73 filed on Apr. 3, 2014, the entire disclosure of which is incorporated by reference herein, is claimed.

### BACKGROUND OF THE INVENTION

1. Field of the Invention

The embodiments of the present invention relate to an access control management apparatus and method for open service components which manages access to the open service components by authenticating the permission of applications that access to the open service components.

2. Discussion of the Related Art

Recently, as the need for the development of faster applications is raised in order to satisfy consumer's demand for various services arising along with the advances in internet and mobile technology, an open application programming interface is now provided on the internet, which enables application services to be easily provided by opening the functions of high reusability in the form of web services and calling this. As such, the service components which are open in the form of web services are executed in a web server engine, and may be called by several applications with being loaded in service platforms that embed the web server engine.

As an example, the “application service system and method thereof” in Korean patent publication No. 10-2012-0061548 (published on Jun. 13, 2012) discloses providing environments in which services may be developed and operated easily by application developers, by performing predefined authentication procedures when an execution request is received for specific service components, and by transferring the execution request for the specific service components to the corresponding service providing apparatus that corresponds to the specific service components based on the result of authentication.

However, in such a case that the service components are used by being called out by each application, it is required to examine whether the application and user that call them out have the rights to use based on pre-registered information and to permit or reject them in order to provide safe service functions. In this time, what is required is an application registration and access control function for service components. In addition, in order to support such a function, it is required for a function to define the relation between applications and service components and also required for a function of management to record the use history.

### SUMMARY OF THE INVENTION

An object of the present invention to solve the problem of described above is to provide an apparatus for managing access of applications for open service components in the form of web service.

Another object of the present invention to solve the problem of described above is to provide a method for managing access of application for open service components in the form of web service.

According to an aspect of the present invention, an access control management apparatus may include a header extractor configured to extract a header from a request message for a service component which is received from an application, an authentication manager configured to authenticate a permission of the application for the service component using an application ID, a service key for the service component and an authorization code which are included in the header and an authentication code, and a history manager configured to store an execution result of the service component if the permission is authenticated.

According to an aspect, the service key may be a unique key which is individually assigned to the application for the service component.

According to another aspect, the authentication code may be an encrypted code which is comprised of combination of the application ID, the service key and a time stamp.

According to yet another aspect, the authentication manager may examine validity of the request message based on the time stamp which is extracted from the header, generate an authentication code by combining the application ID, a service key for the service component which is requested from the application among service keys which are already stored, and the time stamp and encoding it, and authenticate permission of the application for the service component by comparing the authentication code extracted from the header and the generated authentication code.

According to yet another aspect, the history manager may store authentication failure information for the request message if the authentication for the permission is failed.

According to yet another aspect, the access control management apparatus may further include an application registration manager configured to register the application by endowing the application ID to the application, and to assign the service key to the registered application.

According to another aspect of the present invention, a method for managing access to a service component performed by an access control management apparatus may include extracting a header from a request message for the service component which is received from an application, authenticating a permission of the application for the service component using an application ID, a service key for the service component and an authorization code which are included in the header, and storing an execution result of the service component if the permission is authenticated.

### BRIEF DESCRIPTION OF THE DRAWINGS

The accompanying drawings, which are included to provide a further understanding of the present invention and constitute a part of specifications of the present invention, illustrate embodiments of the present invention and together with the corresponding descriptions serve to explain the principles of the present invention.

FIG. 1 is a block diagram illustrating the service platform that includes an access control management apparatus according to an embodiment of the present invention.

FIG. 2 is a drawing illustrating the information included in the header of the service component request message according to an embodiment of the present invention.

FIG. 3 is a block diagram illustrating the access control management apparatus according to an embodiment of the present invention.

FIG. 4 is a flow chart illustrating the procedure of registering an application to a service platform by an access control management apparatus according to an embodiment of the present invention.

FIG. 5 is a flow chart illustrating the procedure that the access control management apparatus of authenticates the permission of the application that requests a service component according to an embodiment of the present invention.

FIG. 6 is a block diagram illustrating the computer system in which an access control management apparatus is implemented according to an embodiment of the present invention.

### DETAILE DESCRIPTION OF THE INVENTION

The embodiment of the present invention now will be described in detail hereinafter by reference to the accompanying drawings in order for the person of ordinary skill in this art to implement easily. However, the present invention can be implemented with various modifications, and not limited in the embodiment described herein. In addition, in order to clearly describe the present invention, a part which is not in relation to the description is omitted in the drawings, and similar reference numbers are denoted for the similar parts throughout the specification.

When a part “includes” a certain element, this means that the part may not exclude other elements but further include them throughout the specification, unless any specific opposite description is presented.

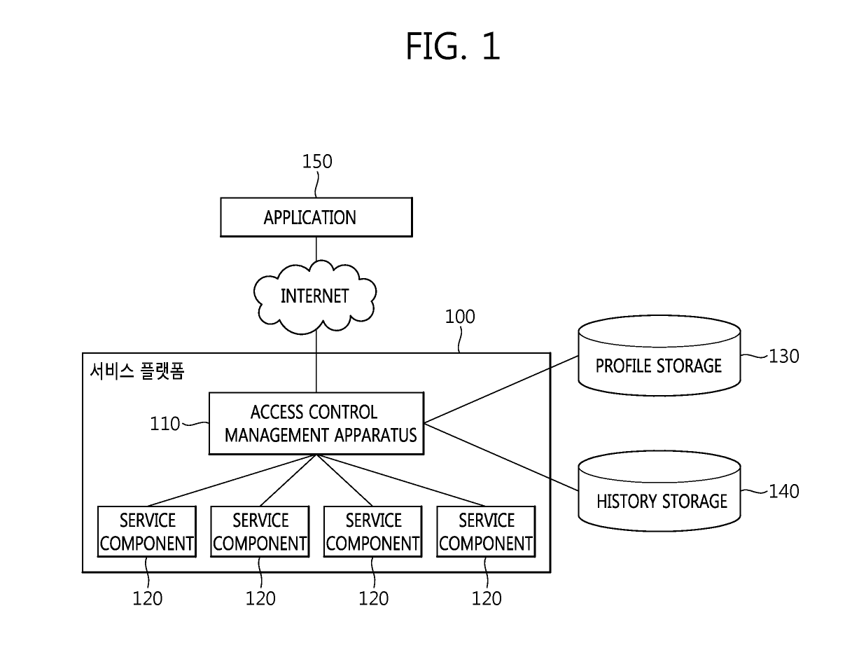

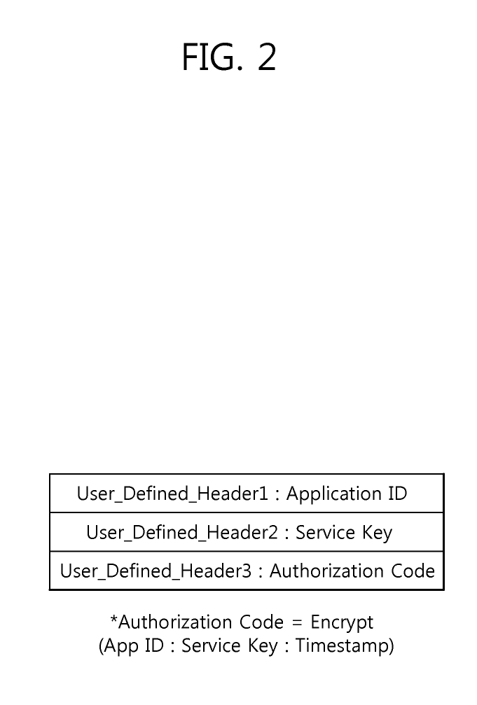

FIG. 1 is a block diagram illustrating the service platform that includes an access control management apparatus according to an embodiment of the present invention, and FIG. 2 is a drawing illustrating the information included in the header of the service component request message according to an embodiment of the present invention.

First, referring to FIG. 1, a service platform 100 includes an access control management apparatus 110 and a plurality of service components 120. The service platform 100 provides an execution function that drives respective service components 120 and management functions such as the registration and authentication of an application 150 that uses the respective service components 120. Each of the service components 120 may be open in the form of web service.

The access control management apparatus 110 analyzes the request message of the application 150 that requests the function of a service component 120 through the internet, and authenticates the right of the application 150 for the requested service component by comparing the information extracted through analyzing and the information stored in a profile storage 130. If the authentication is successful, the call for corresponding service component is forwarded, and the result is stored in a history storage 140. In this time, the information required for right authentication is included in the user defined header of the request message. As depicted in FIG. 2, the user defined header includes an application ID, a service key endowed as 1:1 between the application and the service component, and an authorization code which is encoded by mixing these.

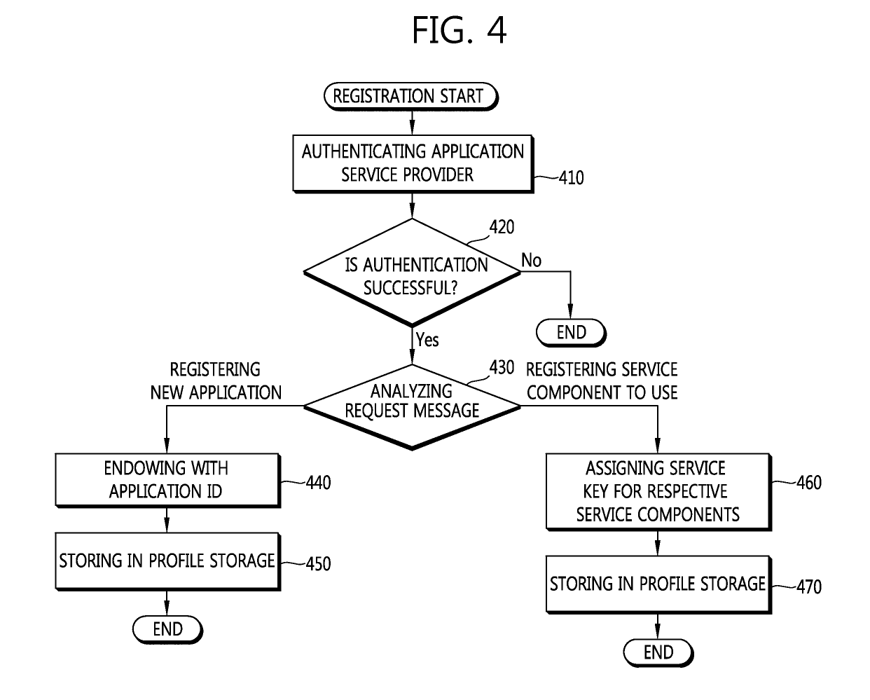

For example, the application ID and the service key may be unique information which is assigned to the application in the process of application registration as shown in FIG. 4, and may be compared with the information which is stored in the profile storage 130. The authentication code may be an encrypted code which is comprised of the combination of an application ID, a service key and a time stamp, which may be used for examining the validity of a service component request message and for determining whether there is a right for the service component which is requested by the application.

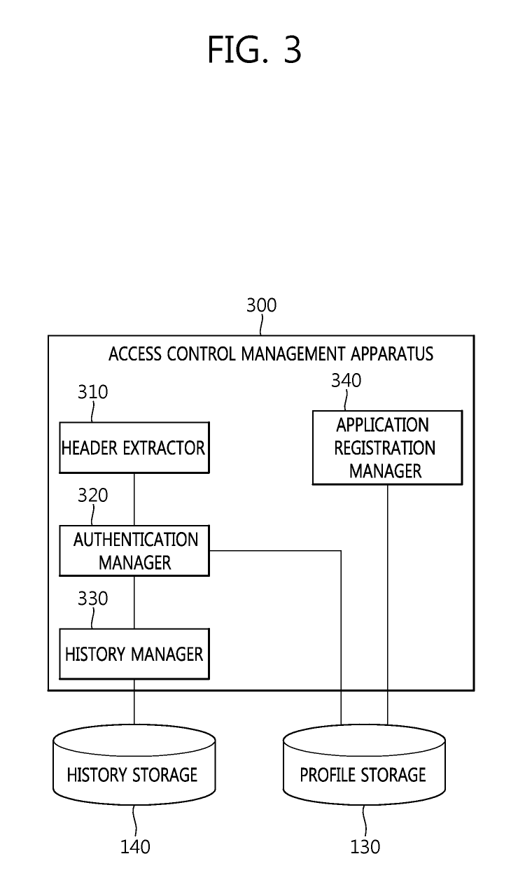

Meanwhile, although it is depicted in FIG. 1 that the profile storage 130 and the history storage 140 are separated from the service platform 100, the profile storage 130 and the history storage 140 may be included in the service platform 100, as occasion demands. Hereinafter, by referring to FIG. 3, the access control management apparatus 110 will be described in more detail according to the present invention.

FIG. 3 is a block diagram illustrating the access control management apparatus according to an embodiment of the present invention. As an example, referring to FIG. 3, the access control management apparatus 300 includes a header extractor 310, an authentication manager 320, a history manager 330 and an application registration manager 340.

The header extractor 310 extracts a user defined header from a request message for a service component received from an application.

When the user defined header is extracted from the request message by the header extractor 310, the authentication manager 320 extracts the application ID included in the extracted user defined header, the service key for the service component, the authentication code, and so on, and authenticates the permission of the application for the service component using the extracted information. Herein, the service key may be a unique key which is individually assigned to an application for the service component, and the authentication code may be an encrypted code which is comprised of the combination of the application ID, the service key and the time stamp.

As an example, the authentication manager 320 examines the validity of the request message based on the time stamp which is extracted from the user-defined header, and in case of being valid, generates an authentication code by encoding with the combination of the application ID, an service key for the service component which is requested by the application among service keys stored in the profile storage 130 and the time stamp. Further, by comparing the authentication code which is extracted from the user defined header and the generated authentication code, the authentication manager 320 authenticates the permission of the application for the service component.

If the permission of the application is authenticated through the authentication manager 320, the history manager 330 stores the execution result of the corresponding service component in the history storage 140. And if the authentication for the permission of the application is failed, the history manager 330 stores the authentication failure information for the request message in the history storage 140. The information stored in the history storage 140 may be used for metering later.

The application registration manager 340 registers the application by endowing application ID to the application, and assigns the service key to the registered application. According to the present invention, the pre-registration procedure of an application is required in order for the application to use the service components. Accordingly, the application registration manager 340 registers the application beforehand, and issues the service key on the service component usage request. The issued service key is provided to the corresponding application, and stored in the profile storage 130 for the permission authentication of the application.

FIG. 4 is a flow chart illustrating the procedure of registering an application to a service platform by an access control management apparatus according to an embodiment of the present invention. Hereinafter, referring to FIG. 4, the process of being endowed with the service key which is required for authentication will be described, which is available by being permitted for the service components in advance from the access control management apparatus by the application.

The application may have the application ID which is identifiable from the service platform, and is endowed with a unique service key for the respective service components, and forwards it with being included in the user-defined header when calling the service. In case that an application service provider firstly registers an application in the service platform, the access control management apparatus authenticates whether the application service provider that forwards the registration request message is the provider registered in the service platform (step, 410). If the authentication is successful (step, 420), the access control management apparatus analyses the received registration request message (step, 430). In case that the application service provider firstly registers the application, the access control management apparatus endows an application ID to the corresponding application (step, 440), and stores this in the profile storage (step, 450). On the other hand, as for the application which is already registered, the access control management apparatus assigns a service key for the respective service components to use (step, 460), and stores this in the profile storage (step, 470).

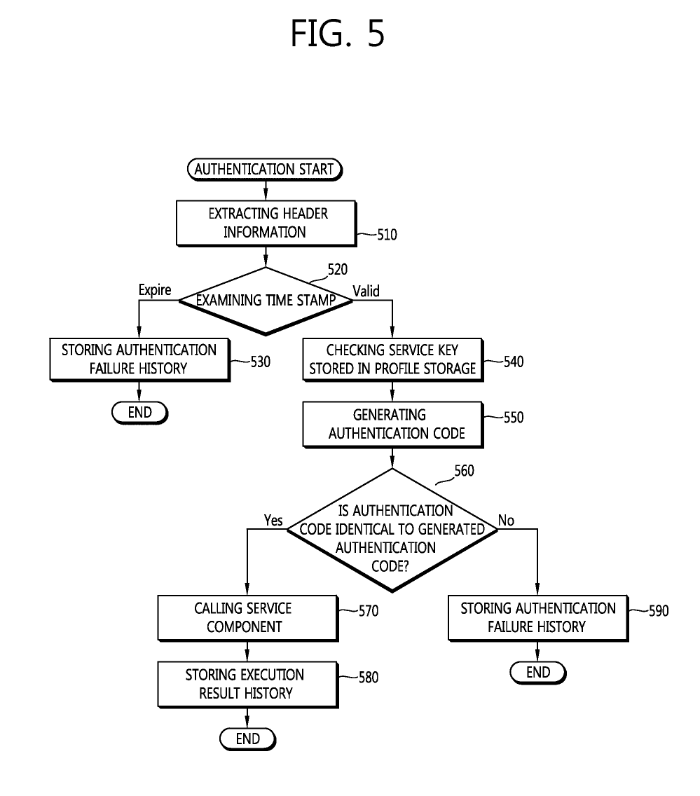

FIG. 5 is a flow chart illustrating the procedure that the access control management apparatus of authenticates the permission of the application that requests a service component according to an embodiment of the present invention.

When the application forwards the request message for a specific service component to a service platform through the internet, the access control management apparatus included in the service platform extracts a user defined header from the received request message (step, 510). In this time, the user defined header may include an application ID, a service key for the service component and an authentication code.

If the user defined header is extracted, the access control management apparatus extracts a time stamp from the user defined header in order to examine the validity of the request message, and identifies whether the request message is arrived within a valid period by examining it (step, 520). If the time stamp is expired, the access control management apparatus determines that the corresponding request message is not valid and stores the authentication failure history in the history storage (step, 530).

On the other hand, if the validity is verified, the access control management apparatus checks the service key between the corresponding application and service component in the profile storage (step, 540), and generates an authentication code by combining the checked service key with the application ID which is the information included in the user defined header and the time stamp and encoding it (step, 550). And the access control management apparatus compares whether the generated authentication code and the authentication code extracted from the user defined header is identical (560). If it is identical, the access control management apparatus calls the requested service component (step, 570) and has the service component be executed by the service platform, and stores the execution result of the corresponding service component in the history storage (step, 580). If they are different, the access control management apparatus stores the authentication failure information in the history storage (step, 590).

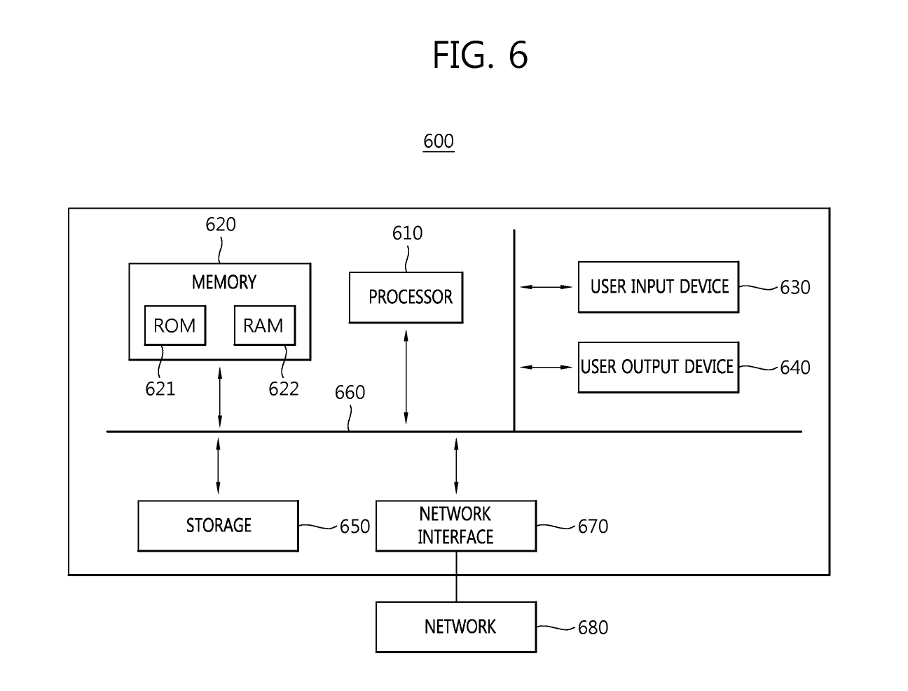

FIG. 6 is a block diagram illustrating the computer system in which an access control management apparatus is implemented according to an embodiment of the present invention.

The access control management apparatus according to the present invention may be implemented by the computer system shown in FIG. 6. The computer system 600 may include at least one processor 610, at least one memory 620 that stores program, a user input device 630, a user output device 640 and a storage 650, and respective elements may be communicated by each other. In addition, the computer system 600 may include a network interface 670 in order to be connected to a network 680.

The processor 610 may be a central processing unit (CPU) or a semiconductor device that executes the program stored in the memory 620 and/or the storage 650. The memory 620 and the storage 650 may include volatile and nonvolatile recording media of various forms. For example, the memory 620 may include a read only memory 621 and a random access memory 622.

So far, the description of the present invention has been exemplary presented, many modifications and variations may be made by those of ordinary skill in the art without departing from the spirit and scope of the present invention. Accordingly, the embodiments disclosed in the present invention are not intended to limit the inventive concept of the present invention, but rather to describe the invention, and the inventive concept is not limited by the embodiments. The scope of the present invention should be interpreted by the claims below, and it should be interpreted that all inventive concepts which are equivalent to it fall into the scope of the present invention.

What is claimed is:

1. An access control management apparatus, comprising:
a header extractor configured to extract a header from a request message for a service component which is received from an application;
an authentication manager configured to authenticate a permission of the application for the service component using an application ID, a service key for the service component and an authorization code which are included in the header; and
a history manager configured to store an execution result of the service component if the permission is authenticated.

2. The access control management apparatus of claim 1, wherein the service key is a unique key which is individually assigned to the application for the service component.

3. The access control management apparatus of claim 1, wherein the authentication code is an encrypted code which is comprised of combination of the application ID, the service key and a time stamp.

4. The access control management apparatus of claim 1, wherein the authentication manager examines validity of the request message based on the time stamp which is extracted from the header,
generates an authentication code by combining the application ID, a service key for the service component which is requested from the application among service keys which are already stored, and the time stamp and encoding it,
authenticates permission of the application for the service component by comparing the extracted authentication code from the header and the generated authentication code.

5. The access control management apparatus of claim 1, wherein the history manager stores authentication failure information for the request message if the authentication for the permission is failed.

6. The access control management apparatus of claim 1 further comprising an application registration manager configured to register the application by endowing the application ID to the application, and to assign the service key to the registered application.

7. A method for managing access to a service component performed by an access control management apparatus, comprising:
extracting a header from a request message for the service component which is received from an application;
authenticating a permission of the application for the service component using an application ID, a service key for the service component and an authorization code which are included in the header; and
storing an execution result of the service component if the permission is authenticated.

8. The method for managing access of claim 7, wherein the service key is a unique key which is individually assigned to the application for the service component.

9. The method for managing access of claim 7, wherein the authentication code is an encrypted code which is comprised of combination of the application ID, the service key and a time stamp.

10. The method for managing access of claim 7, wherein authenticating the permission of the application comprises:
examining validity of the request message based on the time stamp which is extracted from the header;
generating an authentication code by combining the application ID, a service key for the service component which is requested from the application among service keys which are already stored, and the time stamp and encoding it; and
comparing the authentication code extracted from the header and the generated authentication code.

11. The method for managing access of claim 7 further comprising storing authentication failure information for the request message if the authentication for the permission is failed, after authenticating the permission of the application.

12. The method for managing access of claim 7 further comprising:
registering the application by endowing the application ID to the application; and
assigning the service key to the registered application, before extracting the header.
